(19) United States
(12) Patent Application Publication
(10) Pub. No.: US 2005/0077232 A1
(43) Pub. Date: Apr. 14, 2005

(54) Composite membrane for separating organic solvents and the method for fabricating the same

(76) Inventors: Juin Yih Lai, Yangmei Township (TW); Da Ming Wang, Yangmei Township (TW); Kueir Rarn Lee, Chung-Li City (TW); Pei Yun Kuo, Taipei City (TW); Se Tsung Kao, Tainan City (TW); Yu Huei Su, Tainan City (TW)

Correspondence Address: RUBEN C. DELEON;WINSTEAD SECHROST & MINICK P.C., P.O. BOX 50784, DALLAS, TX, 75201, US

(21) Appl. No.: 10/687,304

(22) Filed: Oct. 14, 2003

(51) Int. Cl. B01D 71/06

(52) U.S. Cl. 210/490; 210/500.27; 210/500.41; 210/506; 427/245; 427/402

(57) ABSTRACT

This invention discloses a composite membrane for separating organic solvents that comprises a carrier layer, a support layer and a separation layer. The material of the separation layer is chitosan containing nano-inorganic particles, wherein the nano-inorganic particles are uniformly embedded in the the chitosan separation layer. This invention also discloses a method for fabricating a composite membrane for separating organic solvents. Moreover, the method comprises a dissolution process, a degassing process, a membrane fabrication process, a coating process and a fixation process.

### BACKGROUND OF THE INVENTION

1. Field of the Invention

This present invention relates to a composite membrane for separating organic solvents, and more particularly, to a composite chitosan membrane containing nano-inorganic particles for separating organic solvents and the method for fabricating the same.

2. Description of the Prior Art

Chitosan, a polysaccharide consisting of [(1,4)-2-amino-2-deoxy-β-D-glucan], is a hydrophilic natural polymer, which has received much attention in recent years. Usually, a deacetylation process is taken to produce chitosan from chitin. Chitin is also a natural polymer and consists of [(1,4)-2-acetamido-2-deoxy-β-D-glucan]. Chitin is the major constituent of the exoskeleton of insects and crustaceous aquatic animals, and also the major constituent of the cell wall of fungus. Due to the amino and hydroxyl groups in its molecular structure, chitosan is chemical reactive and easy to be modified to form a variety of derivatives. With the above characteristics, chitosan can be applied in many fields, such as agriculture, medical and health care, food processing, fine chemicals, waste water treatment, and textile and paper-making industries.

Pervaporation is a membrane separation process that can be employed to separate liquid mixtures. It can be used to separate liquid mixtures with azeotrope. In addition, it comprises advantages such as easy operation, energy saving, and others. Therefore, pervaporation attracts much attention in industry. The key to the development of pervaporation is the preparation of membranes with excellent separation performance. The separation stems from the difference in the penetration rates of each component in the feed crossing the membrane, and the permeation rate is determined by each component's solubility and diffusivity in the membrane. The diffusivity is related to the size of the molecule permeating through the membrane and the solubility is related to the affinity between the permeating molecules and the membrane. Thus, one strategy to improve the pervaporation performance is to adjust the affinity between the membrane and the preferred components. For example, synthesizing a material with special hydrophilic properties or modifying commercial materials to raise the hydrophilicity is usually used. Another application is to control the membrane structure to adjust the permeating components' diffusivity in the membrane. Because of its high hydrophilicity and good membrane-forming property, chitosan is a good material for pervaporation.

Another membrane separation process similar to pervaporation is vapor permeation. The vapor permeation process first vaporizes the organic liquid feed, then brings the membrane in contact with the vapor feed. The major difference between these two processes is the state of their feeds. Pervaporation is with liquid feed and vapor permeation is with vapor feed. Generally, vapor permeation is more suitable for separation feeds containing dissolved solids or feeds with impurities. Vapor permeation is also appropriate to be attached to a distillation column for continuously separating the vapor distillate.

There are three important indexes for separation performance of pervaporation and vapor permeation: selectivity (α), flux and PSI (pervaporation separation index). In a binary system comprising component i and component j, the selectivity is defined as (Yᵢ/Yⱼ)/(Xᵢ/Xⱼ), wherein Xᵢ and Xⱼ are the weight percentages in the feed, and Yᵢ and Yⱼ are the weight percentages in the permeate; i denotes the preferred component. The flux is defined as W/(A×t), wherein W is the mass of the permeate, A is the membrane area that allows the feed component to permeate, and t is the operation time. In addition, the PSI (pervaporation separation index) is defined as the product of the selectivity and the flux. Higher value of PSI indicates better separation performance. Generally speaking, PSI is a convenient index for evaluation of the membrane performance in pervaporation and vapor permeation.

Chitosan can be prepared by a dry process, in which the chitosan/acid/water solution is evaporated to remove water and to form dense membranes. However, such membranes cannot be directly used in the pervaporation process because the chitosan membrane will re-dissolve when contacting with aqueous solution, this is caused by the residual acid in the membrane; even after the removal of the residual acid, the membrane will still be unstable when being applied to the pervaporation process because of the swelling effect by the feed aqueous solution. Thus, a crosss-linking process is usually required. Sulfuric acid, aldehyde, and dialdehyde are common crosslinkers. After cross-linking, the stability and permselectivuty are improved, but the permeation flux is low (Uragami and Tadashi, U.S. Pat. No. 5,006,255), which limits the application of chitosan membranes in pervaporation.

There are various methods disclosed for improving the pervaporation performance of chitosan membranes. One of these methods is to blend materials having negative charge with chitosan to form polyelectrolyte. Although the chitosan-polyelectrolyte membrane possesses high selectivity in separation of ethanol/water system, the low flux limits its application. Another method is to blend negatively charged surfactants with chitosan to electrically bond the hydrophilic end (with negative charge) of the surfactant and the NH₃⁺ group in chitosan. The organophilic ends of the surfactants can move freely and, when the surfactant concentration increases, the organophilic ends aggregate to form micelles. Such a process also produces chitosan membranes with high selectivity but low flux. Since the hydrophilic ends are bonded to the polymer chain, the aggregation of the organophilic ends would result in folded polymer chain and thus reduce the free volume of the prepared chitosan membrane. As a result, the surfactant blended membrane possesses high selectivity but low flux. Another method is to coat alginate on a chitosan membrane. Therefore, a new process is still required to prepare chitosan membranes that possess high selectivity, high flux, and high stability for the pervaporation process.

### SUMMARY OF THE INVENTION

In accordance with the present invention, a composite chitosan membrane is provided, the chitosan membrane posses high selectivity, high flux, and high stability for the pervaporation process, and can meet the requirement for large-scale operation.

It is one of the objects of this invention to fabricate a composite membrane with ultra-thin separation layer for increasing the flux in the membrane separation process. Furthermore, this invention stabilizes the mechanical strength of the composite membrane by the carrier layer and support layer. The selectivity of the composite membrane for feeds could be maintained as the same as that of a homogeneous dense membrane, while this invention could provide a membrane with higher flux comparing to that of a homogeneous dense membrane. Since membrane flux should be high enough for high throughput applications, the present invention does have economic advantages for industrial applications.

This invention provides a composite membrane for separating organic solvents. The composite membrane comprises a carrier layer, a support layer and a separation layer. The material of the separation layer is chitosan containing nano-inorganic particles, wherein the nano-inorganic particles are uniformly embedded in the chitosan separation layer. The forming method of the separation layer is described in the previous application of the same inventers (Chitosan membrane having nano-inorganic particles and the method for forming the same, applications for Taiwan and United States, the application number of Taiwan application is 92112934). By combining both characteristics of the organic and inorganic material, the provided composite membrane has good separation performance. This invention also discloses a method for fabricating the composite membrane, and the method comprises a dissolution process, a degassing process, a membrane fabrication process, a coating process and a fixation process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a flowchart of a method of forming a composite membrane for separating organic solvents, wherein the method is provided in the first preferred embodiment of this invention;

FIG. 2 shows a flowchart of a method of forming a composite membrane with a replacement process for separating organic solvents, wherein the method is provided in the second preferred embodiment of this invention;

FIG. 3 shows a flowchart of a method of forming a composite membrane, with a surface modification process, for separating organic solvents, wherein the method is provided in the third preferred embodiment of this invention; and

FIG. 4 shows a representative three-layer structure composite membrane according to this invention, wherein the composite membrane has a carrier layer, a support layer and a separation layer.

### DESCRIPTION OF THE PREFERRED EMBODIMENTS

What is probed into in the invention is about a composite membrane for separating organic solvents and a method for forming the same. Detailed descriptions of the production, structure and elements will be provided in the following in order to make the invention thoroughly understood. Obviously, the application of the invention is not confined to specific details familiar to those who are skilled in the composite membrane for separating organic solvents. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

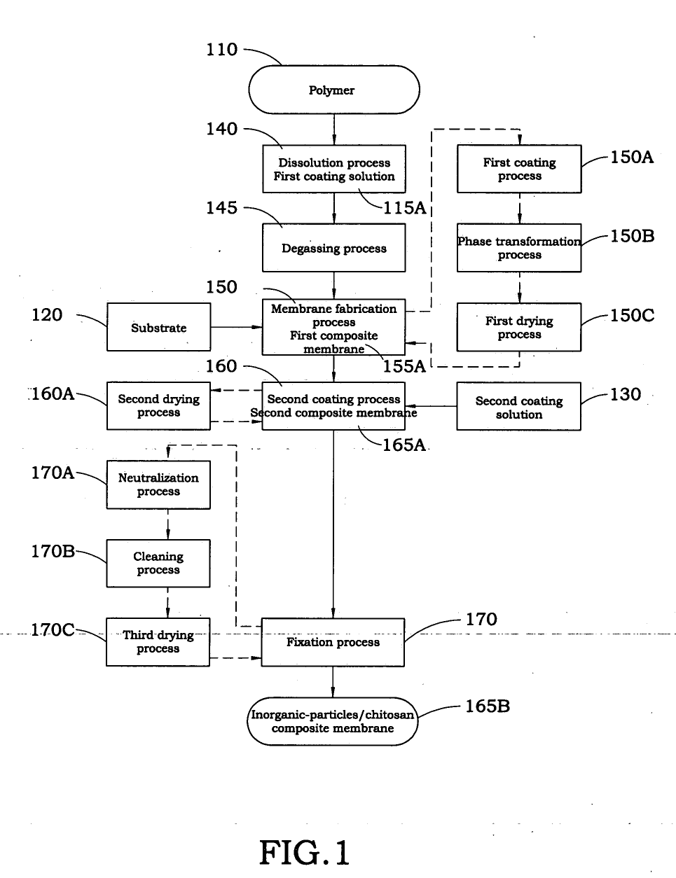

Referring to FIG. 1, which illustrates the first preferred embodiment of this invention, a polymer 110 and a substrate 120 are provided, wherein the polymer 110 could adhere to the substrate 120 to form a layer structure. The substrate 120 comprising a woven, a non-woven, a fabric textile or a knitted textile, and a non-woven substrate 120 is taken for example to form a carrier layer of the composite membrane in this embodiment. The material of the polymer 110 comprises a polysulfone, a polyacrylonitrile, a polyacrylamide, a polyethersulfone, a polyetherketone or a polyetheretherketone, wherein the common dissolution agent of the polysulfone comprises a 1-Methtl-2-Pyrrolidone (NMP), a N,N-Dimethylformamide (DMF), a Dimethyl sulfoxide (DMSO), a chloroform or a Tetrahydrofuran (THF). On the other hand, the common dissolution agent of the polyacrylonitrile comprises a 1-Methtl-2-Pyrrolidone (NMP), a N,N-Dimethylformamide (DMF) or a N,N-Dimethylacetamide (DMAc). Next, the polymer 110 is delivered into a mixing apparatus, and a dissolution process 140 is performed to dissolute the polymer 110 in a dissolution agent to form a first coating solution 115A. In the case that the polymer 110 is polysulfone, the polymer concentration is about 10 wt % to 30 wt % of the first coating solution 115A, wherein 15 wt % to 20 wt % is preferred. Besides, in the case that the polymer 110 is polyacrylonitrile, the concentration is about 8 wt % to 25 wt % of the first coating solution 115A, wherein 10 wt % to 15 wt % is preferred. The first coating solution 115A is then delivered to a degassing apparatus, and a degassing process 145 is performed to remove the bubbles from the first coating solution 115A, wherein the degassing process 145 comprises a shaking process and a sitting process. The shaking process further comprises an ultrasonic shaking process.

Referring to FIG. 1, in this embodiment, the first coating solution 115A and the substrate 120 are transported to a membrane fabrication apparatus and a membrane fabrication process 150 is performed to form a first composite membrane 155A. The membrane fabrication process 150 comprises a first coating process 150A, a phase transformation process 150B and a first drying process 150C. The membrane fabrication apparatus comprises a first coating apparatus, a phase transformation apparatus and a first drying apparatus. The first coating process 150A is to coat the first coating solution 115A with a specific thickness on the substrate 120 in a first coating apparatus. After the first coating process 150A, a phase transformation process 150B is performed to transform the coating solution into solid structure with specific porosity and thickness, and then a support layer of the composite membrane is fabricated, so as to form the first composite membrane 155A. The phase transformation process 150B comprises a polymer non-solvent according to the polymer 110 to solidify the first coating solution 115A, wherein an aqueous solution is taken for example in this embodiment. Afterward, a first drying process 150C is performed to remove the solution from the first composite membrane 155A by a first drying apparatus, wherein the temperature of the first drying process 150C comprises 10° C. to 100° C. In addition, with increasing coating thickness of the first coating solution 115A, longer drying time is needed for the first drying process 150C.

Referring to FIG. 1, in this embodiment, a second coating solution 130 is provided to form a separation layer of the composite membrane, and the second coating solution 130 comprises a chitosan, a nano-inorganic particle and an organic acid, wherein the nano-inorganic particle further comprises a 5A zeolite, a silica or a clay. The forming method of the second coating solution 130 is described in the previous application of the same inventers (Chitosan membrane having nano-inorganic particles and the method for forming the same, applications for Taiwan and United States, the application number of Taiwan application is 92112934). Next, the first composite membrane 155A and the second coating solution 130 are delivered to a second coating apparatus and a second coating process 160 is performed to form a second composite membrane 165A. The second coating process 160 comprises a second drying process 160A, and the second coating apparatus comprises a second drying device. During the coating process 160, the second coating solution 130 is transported into the coating apparatus and the second drying process 160A is performed to form the acid-containing second composite membrane 165A with specific shape and thickness. Generally, the drying temperature is dependent on the concentration of chitosan in the second coating solution 130. In order to avoid the aggregation of the nano-inorganic particles, the temperature of the second drying process 160A increases with decreasing chitosan concentration. The temperature of the second drying process 160A comprises 10° C. to 100° C. In addition, with increasing thickness of the coating solution 130, longer drying time is needed for the second drying process 160A.

Referring to FIG. 1, in this embodiment, after the second coating process 160, the acid-containing second composite membrane 165A is transported to a fixation apparatus, and a fixation process 170 is performed to form a stabilized inorganic-particles/chitosan composite membrane 165B for separating organic solvents. The fixation process 170 comprises a neutralization process 170A, a cleaning process 170B, and a third drying process 170C. The fixation apparatus comprises a neutralization apparatus, a cleaning apparatus, and a third drying apparatus. After the neutralization process 170A is performed in the neutralization apparatus, a neutralization by-product is formed. Subsequently, the by-product of neutralization is removed by the cleaning process 170B. The process 170A comprises an immersing step into an alkaline solution, wherein the alkaline solution is about 1N to 10N. The alkaline solution further comprises a sodium hydroxide solution. The cleaning agent used in the cleaning process 170B comprises a volatile solution for washing, wherein the volatile solution for washing further comprises an ethanol aqueous solution containing about 10 to 99 wt % of ethanol. The temperature in the third drying process 170C is about 10° C. to 70° C. The third drying apparatus further comprises a baking apparatus or a vacuum apparatus.

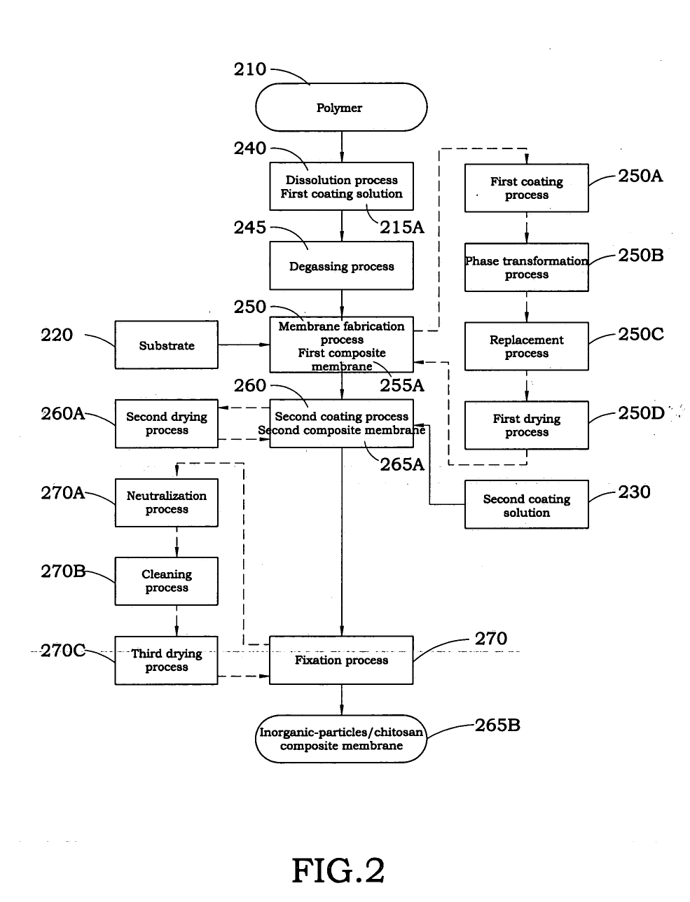

Referring to FIG. 2, in the second preferred embodiment of this invention, first of all, a polymer 210 and a substrate 220 are provided, wherein the polymer 210 could adhere to the substrate 220 to form a layer structure. The substrate 220 comprises a woven, a non-woven, a fabric textile or a knitted textile, and a non-woven substrate 220 is taken for example to form a carrier layer of the composite membrane in this embodiment. The material of the polymer 210 comprises a polysulfone, a polyacrylonitrile, a polyacrylamide, a polyethersulfone, a polyetherketone or a polyetheretherketone, wherein the common dissolution agent of the polysulfone comprises a 1-Methtl-2-Pyrrolidone (NMP), a N,N-Dimethylformamide (DMF), a Dimethyl sulfoxide (DMSO), a chloroform or a Tetrahydrofuran (THF). On the other hand, the common dissolution agent of the polyacrylonitrile comprises a 1-Methtl-2-Pyrrolidone (NMP), a N,N-Dimethylformamide (DMF) or a N,N-Dimethylacetamide (DMAc). Next, the polymer 210 is delivered into a mixing apparatus, and a dissolution process 240 is performed to dissolute the polymer 210 in a dissolution agent to form a first coating solution 215A. In the case that the polymer 210 is polysulfone, the polymer concentration is about 10 wt % to 30 wt % of the first coating solution 215A, wherein 15 wt % to 20 wt % is preferred. In the case that the polymer 210 is polyacrylonitrile, the polymer concentration is about 8 wt % to 25 wt % of the first coating solution 215A, wherein 10 wt % to 15 wt % is preferred. The first coating solution 215A is then delivered to a degassing apparatus, and a degassing process 245 is performed to remove the bubbles from the first coating solution 215A, wherein the degassing process 245 comprises a shaking process and a sitting process. The shaking process further comprises an ultrasonic shaking process.

Referring to FIG. 2, in this embodiment, the first coating solution 215A and the substrate 220 are transported to a membrane fabrication apparatus and a membrane fabrication process 250 is performed to form a first composite membrane 255A. The membrane fabrication process 250 comprises a first coating process 250A, a phase transformation process 250B, at least one replacement process 250C and a first drying process 250D. The membrane fabrication apparatus comprises a first coating apparatus, a phase transformation apparatus, a replacement apparatus and a first drying apparatus. The first coating process 250A is to coat the first coating solution 215A with a specific thickness on the substrate 220 in a first coating apparatus. After the first coating process 250A, a phase transformation process 250B is performed to transform the coating solution into solid structure with specific porosity and thickness, and then a support layer of the composite membrane is fabricated, so as to form the first composite membrane 255A. The phase transformation process 250B comprises a polymer non-solvent according to the polymer 210 to solidify the first coating solution 215A, wherein an aqueous solution is taken for example in this embodiment. Afterward, performing at least one replacement process 250C to replace the solution of said first composite membrane 255A, wherein the replacement process 250C comprises at least one organic solution. When the species of the organic solvent of every replacement process is the same, the concentration of the organic solvents is proportional to the number of times of the replacement process 250C; when the species of the organic solvents of every replacement process is different, the contact angle of the organic solvents of every replacement process increases with the increasing number the replacement process 250C. For example, the number of the replacement process 250C is twice, wherein the first replacement process 250C comprises an ethanol solution, and the second replacement process 250C comprises a cyclohexane solution. After the at least one replacement process 250C, a first drying process 250D is performed to remove the solution from the first composite membrane 255A by a first drying apparatus, wherein the temperature of the first drying process 250D comprises 10° C. to 100° C. In addition, with increasing coating thickness of the first coating solution 215A, longer drying time is needed for the first drying process 250D.

Referring to FIG. 2, in this embodiment, a second coating solution 230 is provided to form a separation layer of the composite membrane, and the second coating solution 230 comprises a chitosan, a nano-inorganic particle and an organic acid, wherein the nano-inorganic particle further comprises a 5A zeolite, a silica or a clay. The forming method of the second coating solution 230 is described in the previous application of the same inventers (Chitosan membrane having nano-inorganic particles and the method for forming the same, applications for Taiwan and United States, the application number of Taiwan application is 92112934). Next, the first composite membrane 255A and the second coating solution 230 are delivered to a second coating apparatus and a second coating process 260 is performed to form a second composite membrane 265A. The second coating process 260 comprises a second drying process 260A, and the second coating apparatus comprises a second drying device. During the coating process 260, the second coating solution 230 is transported into the coating apparatus and the second drying process 260A is performed to form the acid-containing second composite membrane 265A with specific shape and thickness. Generally, the drying temperature is dependent on the concentration of chitosan in the second coating solution 230. In order to avoid the aggregation of the nano-inorganic particles, the temperature of the second drying process 260A increases with decreasing chitosan concentration. The temperature of the second drying process 260A comprises 10° C. to 100° C. In addition, with increasing thickness of the coating solution 230, longer drying time is needed for the second drying process 260A.

Referring to FIG. 2, in this embodiment, after the second coating process 260, the acid-containing second composite membrane 265A is transported to a fixation apparatus, and a fixation process 270 is performed to form a stabilized inorganic-particles/chitosan composite membrane 265B for separating organic solvents. The fixation process 270 comprises a neutralization process 270A, a cleaning process 270B, and a third drying process 270C. The fixation apparatus comprises a neutralization apparatus, a cleaning apparatus, and a third drying apparatus. After the neutralization process 270A is performed in the neutralization apparatus, a neutralization by-product is formed. Subsequently, the by-product of neutralization is removed by the cleaning process 270B. The process 270A comprises an immersing step into an alkaline solution, wherein the alkaline solution is about 1N to 10N. The alkaline solution further comprises a sodium hydroxide solution. The cleaning agent used in the cleaning process 270B comprises a volatile solution for washing, wherein the volatile solution for washing further comprises an ethanol aqueous solution containing about 10 to 99 wt % of ethanol. The temperature in the third drying process 270C is about 10° C. to 70° C. The third drying apparatus further comprises a baking apparatus or a vacuum apparatus.

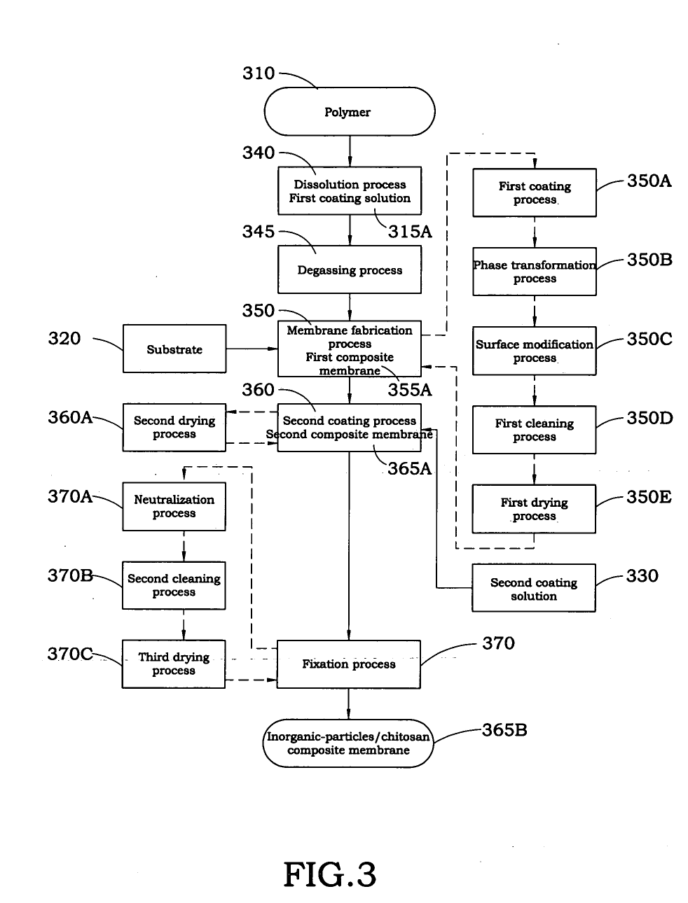

Referring to FIG. 3, in the third preferred embodiment of this invention, a polymer 310 and a substrate 320 are provided, wherein the polymer 310 could adhere to the substrate 320 to form a layer structure. The substrate 320 comprises a woven, a non-woven, a fabric textile or a knitted textile, and a non-woven substrate 320 is taken for example to form a carrier layer of the composite membrane in this embodiment. The material of the polymer 310 comprises a polymer having a nitrile group (—C≡N), such as polyacrylonitrile, wherein the common dissolution agent of the polyacrylonitrile comprises a 1-Methtl-2-Pyrrolidone (NMP), a N,N-Dimethylformamide (DMF) or a N,N-Dimethylacetamide (DMAc). Next, the polymer 310 is delivered into a mixing apparatus, and a dissolution process 340 is performed to dissolute the polymer 310 in a dissolution agent to form a first coating solution 315A. In the case that the polymer 310 is polyacrylonitrile, the polymer concentration is about 8 wt % to 25 wt % of the first coating solution 315A, wherein 10 wt % to 15 wt % is preferred. The first coating solution 315A is then delivered to a degassing apparatus and a degassing process 345 is performed to remove the bubbles from the first coating solution 315A, wherein the degassing process 345 comprises a shaking process and a sitting process. The shaking process further comprises an ultrasonic shaking process.

Referring to FIG. 3, in this embodiment, the first coating solution 315A and the substrate 320 are transported to a membrane fabrication apparatus and a membrane fabrication process 350 is performed to form a first composite membrane 355A. The membrane fabrication process 350 comprises a first coating process 350A, a phase transformation process 350B, a surface modification process 350C, a first cleaning process 350D and a first drying process 350E. The membrane fabrication apparatus comprises a first coating apparatus, a phase transformation apparatus, a surface modification apparatus, a first cleaning apparatus and a first drying apparatus. The first coating process 350A is to coat the first coating solution 315A with a specific thickness on the substrate 320 in a first coating apparatus. After the first coating process 350A, a phase transformation process 350B is performed to transform the coating solution into solid structure with specific porosity and specific thickness, and then a support layer of the composite membrane is fabricated, so as to form the first composite membrane 355A. The phase transformation process 350B comprises a polymer non-solvent according to the polymer 310 to solidify the first coating solution 315A, wherein an aqueous solution is taken for example in this embodiment. Afterward, a surface modification process 350C is performed to modify the functional group on the first composite membrane 355A. In the case that the polymer 310 is polyacrylonitrile, the surface modification process 350C comprises an alkaline solution with concentration greater than 0.25 N. The alkaline solution further comprises a sodium hydroxide solution. The temperature of the surface modification process 350C decreases with increasing concentration of the alkaline solution. In addition, with increasing temperature of the surface modification process 350C, shorter operating time is needed. Subsequently, a first cleaning process 350D is performed to remove the alkaline solution from the first composite membrane 355A by a cleaning agent. After first cleaning process 350D, first drying process 350E is performed to remove the cleaning agent from the first composite membrane 355A by a first drying apparatus, wherein the temperature of the first drying process 350E comprises 10° C. to 100° C. In addition with increasing coating thickness of the first coating solution 315A, longer drying time is needed for the first drying process 350E.

Referring to FIG. 3, in this embodiment, a second coating solution 330 is provided to form a separation layer of the composite membrane, and the second coating solution 330 comprises a chitosan, a nano-inorganic particle and an organic acid, wherein the nano-inorganic particle further comprises a 5A zeolite, a silica or a clay. The forming method of the second coating solution 330 is described in the previous application of the same inventers (Chitosan membrane having nano-inorganic particles and the method for forming the same, applications for Taiwan and United States, the application number of Taiwan application is 92112934). Next, the first composite membrane 355A and the second coating solution 330 are delivered to a second coating apparatus and a second coating process 360 is performed to form a second composite membrane 365A. The second coating process 360 comprises a second drying process 360A, and the second coating apparatus comprises a second drying device. During the coating process 360, the second coating solution 330 is transported into the coating apparatus and the second drying process 360A is performed to form the acid-containing second composite membrane 365A with specific shape and thickness. Generally, the drying temperature is dependent on the concentration of chitosan in the second coating solution 330. In order to avoid the aggregation of the nano-inorganic particles, the temperature of the second drying process 360A increases with decreasing chitosan concentration. The temperature of the second drying process 360A comprises 10° C. to 100° C. In addition, with increasing thickness of the coating solution 330, longer drying time is needed for the second drying process 360A.

Referring to FIG. 3, in this embodiment, after the second coating process 360, the acid-containing second composite membrane 365A is transported to a fixation apparatus, and a fixation process 370 is performed to form a stabilized inorganic-particles/chitosan composite membrane 365B for separating organic solvents. The fixation process 370 comprises a neutralization process 370A, a second cleaning process 370B, and a third drying process 370C. The fixation apparatus comprises a neutralization apparatus, a cleaning apparatus, and a third drying apparatus. After the neutralization process 370A is performed in the neutralization apparatus, a neutralization by-product is formed. Subsequently, the by-product of neutralization is removed by the second cleaning process 370B. The neutralization process 370A comprises an immersing step into an alkaline solution, wherein the alkaline solution is about 1N to 10N. The alkaline solution further comprises a sodium hydroxide solution. The cleaning agent used in the cleaning process 370B comprises a volatile solution for washing, wherein the volatile solution for washing further comprises an ethanol aqueous solution containing about 10 to 99 wt % of ethanol. The temperature in the third drying process 370C is about 10° C. to 70° C. The third drying apparatus further comprises a baking apparatus or a vacuum apparatus.

According to the above-mentioned embodiments, this invention discloses a technology about fabricating a composite membrane with three layers structure for separating organic solvents, wherein the composite membrane comprises a carrier layer, a support layer and a separation layer. The separation layer comprises a chitosan containing nano-inorganic particles, and the method for forming the separation layer is described in the previous application. It is one of the objects of this invention to fabricate a composite membrane with ultra-thin separation layer for increasing the flux in the membrane separation process. Furthermore, this invention stabilizes the mechanical strength of the composite membrane by the carrier layer and support layer. The selectivity of the composite membrane for feed could be maintained as the same as that of a homogeneous dense membrane, while this invention could provide higher flux comparing to that of a homogeneous dense membrane. Therefore, the present invention does have economic advantages for industrial applications.

The composite membranes fabricated according to the above-mentioned embodiments are applied in pervaporation process for separating organic solvents, and one result of the pervaporation process is as follows: The composite membrane of this invention was used to separate an aqueous feed containing 90 wt % of ethanol at 70 □. The present invention provides two kinds of composite membranes in this system: one kind shows flux being 564 g/m² per hour and water selectivity being 2241, so the PSI value is 1263924; the other kind shows flux being 810 g/m² per hour and selectivity being 171, so the PSI value is 138510. On the contrary, the conventional composite membrane was used to separate an aqueous feed containing 90 wt % of ethanol at 80 □. The conventional composite membrane shows flux being 500 g/m² per hour and water selectivity being 171, so the PSI value is 85500. It is obviously that the performance of this invention is better than that of conventional skills. On the other hand, the composite membrane of this invention was used to separate an aqueous feed containing 90 wt % of 2,2,3,3-tetrafluoro-1-propanol (TFP) at 70 □. The composite membrane of this invention shows flux being 487 g/m² per hour and water selectivity being 382. There are no appropriate conventional skills to deal with 2,2,3,3-tetrafluoro-1-propanol (TFP) aqueous solution. Therefore, the present invention could be applied to a new field.

Other applications according to this invention to different pervaporation systems are as follows: one of the composite membranes of this invention was used to separate an aqueous feed containing 90 wt % of Iso-propyl alcohol (IPA) at 70 □, and shows flux being 770 g/m² per hour and water selectivity being 250, so the PSI value is 192500. On the contrary, the conventional membrane was used to separate feed containing 90 wt % of Iso-propyl alcohol (IPA) at 80 □, and shows flux being 1000 g/m² per hour and water selectivity being 171, so the PSI value is 171000. Obviously, the performance of this invention is better than that of conventional skills. Moreover, the composite membranes of this invention could be applied to other systems for separating organic solvents, such as: bezene/cyclohexane, bezene/toluene, MTBE/methyl alcohol, etc.

In addition, the composite membrane of the present invention could be applied to other membrane separation process such as vapor permeation. Actually, vapor permeation process is similar to pervaporation process, the main difference between these two processes is the state of the feed: the membrane contacts liquid feed in pervaporation, while the membrane contacts vapor feed in vapor permeation. One result of the vapor permeation process according to this study is as follows: the composite membrane of this invention was used to separate an aqueous feed containing 80 wt % of N,N-Dimethylformamide (DMF) at 30 □. The composite membrane of this invention shows flux being 325 g/m² per hour and the water concentration of permeate is about 100 wt %. On the contrary, there are no appropriate conventional skills to deal with N,N-Dimethylformamide (DMF) aqueous solution. Therefore, the present invention could be applied in a new field.

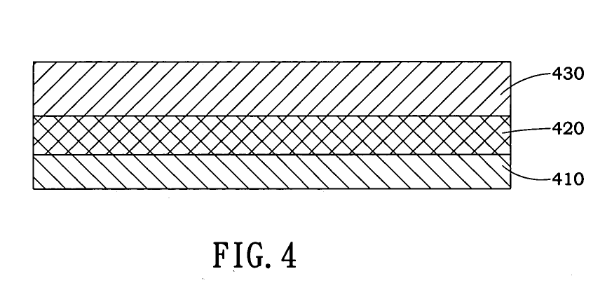

The present invention discloses a composite chitosan membrane containing nano-inorganic particles for separating organic solvents and the method for fabricating the same. According to these embodiments of this invention, the composite membrane comprises a carrier layer, a support layer and a separation layer. The material of the separation layer is chitosan containing nano-inorganic particles, wherein the nano-inorganic particles are uniformly embedded in the chitosan separation layer. Besides, the support layer comprises a polymer that could adhere to the carrier layer to form a layer structure. For example, the material of the support layer comprises polysulfone, polyacrylonitrile, etc. The representative figure of the three-layer structure composite membrane is shown in FIG. 4, wherein 410 is the carrier layer, 420 is the support layer and 430 is the separation layer. Obviously, besides the preparation of the composite chitosan membranes containing nano-inorganic particles for separating organic solvents, the design of this invention could also be applied to the preparation of other composite polymeric membranes that contain nano-inorganic particles for separating organic solvents.

Although only three specific embodiments have been illustrated and described, it will be obvious to those skilled in this art that various modifications may be made without departing from what is intended to be limited solely by the appended claims. Obviously, many modifications and variations of the present invention are possible in light of the above teachings. It is therefore to be understood that within the scope of the appended claims, the present invention may be practiced otherwise than as specifically described herein.

1. A method of forming a composite membrane for separating organic solvents, comprising:
providing a polymer and a substrate;
dissolving said polymer to form a first coating solution;
performing a membrane fabrication process to coat said first coating solution on said substrate to form a first composite membrane;
providing a second coating solution comprising a chitosan, a nano-inorganic particle and an organic acid;
coating said second coating solution on said first composite membrane to form a second composite membrane; and
performing a fixation process to neutralize said second composite membrane and to form a composite membrane for separating organic solvents.

2. The method according to claim 1, wherein said membrane fabrication process comprises:
coating said first coating solution with specific thickness on said substrate;
performing a phase transformation process to transform said first coating solution into solid structure with specific porosity and specific thickness, so as to form said first composite membrane; and
removing the solution from said first composite membrane.

3. The method according to claim 2, wherein said phase transformation process comprises a polymer non-solvent according to said polymer to solidify said first coating solution.

4. The method according to claim 1, wherein said fixation comprises:
neutralizing said second composite membrane by an alkaline solution and a by-product of neutralization is formed;
removing said by-product of neutralization from said second composite membrane by a cleaning agent; and
removing said cleaning agent from said second composite membrane to form said composite membrane for separating organic solvents.

5. The method according to claim 1, wherein said membrane fabrication process comprises:
coating said first coating solution with specific thickness on said substrate;
performing a phase transformation process to transform said first coating solution into solid structure with specific porosity and specific thickness, so as to form said first composite membrane;
performing at least one replacement process to replace the solution of said first composite membrane by at least one organic solution; and
removing the organic solution from said first composite membrane.

6. The method according to claim 5, wherein said phase transformation process comprises a polymer non-solvent according to said polymer to solidify said first coating solution.

7. The method according to claim 5, wherein the species of the organic solvent of every replacement process is the same.

8. The method according to claim 7, wherein the concentration of said organic solvents is proportional to the number of said replacement process.

9. The method according to claim 5, wherein the species of the organic solvents of every replacement process is different.

10. The method according to claim 9, wherein the contact angle of the organic solvents of every said replacement process increases with the increasing number of said replacement process.

11. The method according to claim 1, wherein said polymer comprises a polymer having a nitrile group (—C≡N).

12. The method according to claim 11, wherein said membrane fabrication process comprises:
coating said first coating solution with specific thickness on said substrate;
performing a phase transformation process to transform said first coating solution into solid structure with specific porosity and specific thickness, so as to form said first composite membrane;
performing a surface modification process to modify the functional group on said first composite membrane;
removing the surface modifying solution from said first composite membrane by a cleaning agent; and
removing said cleaning agent from said first composite membrane.

13. The method according to claim 12, wherein said phase transformation process comprises a polymer non-solvent according to said polymer to solidify said first coating solution.

14. The method according to claim 12, wherein said surface modification process comprises an alkaline solution with concentration greater than 0.25 N.

15. The method according to claim 14, wherein said alkaline solution further comprises a sodium hydroxide solution.

16. A structure of a composite membrane for separating organic solvents, comprising:
a carrier layer;
a support layer, wherein said support layer has a first surface and a second surface, and said support layer connects to a surface of said carrier layer with said first surface thereof; and
a separation layer, wherein said separation layer formed on said second surface of said support layer comprises a nano-inorganic particle and a chitosan.

17. The structure according to claim 17, wherein said carrier layer comprises a non-woven.

18. The structure according to claim 17, wherein the material of said support layer comprises a polysulfone.

19. The structure according to claim 17, wherein the material of said support layer comprises a polyacrylonitrile.
